(19) United States
(12) Patent Application Publication
(10) Pub. No.: US 2016/0159599 A1
(43) Pub. Date: Jun. 9, 2016

(54) Die-cut tape

(71) Applicant: Juan Verdu Ferrandiz, Madrid (ES)

(72) Inventor: Juan Verdu Ferrandiz, Madrid (ES)

(21) Appl. No.: 14/561,247

(22) Filed: Dec. 5, 2014

(51) Int. Cl. B65H 18/28; C09J 7/02

(52) U.S. Cl. CPC B65H 18/28; C09J 7/02; C09J 2201/20

(57) ABSTRACT

A die-cut tape essentially characterized by being formed from a conventional adhesive tape (3) rolled on a shaft (1) determining its storage as a roll where a series of small dies (4) are made in said adhesive tape (3) placed perpendicular to the main axis of the tape (3) at regular intervals. Where the distance between the lines of dies may be variable, the dies may be placed perpendicularly or obliquely from the main shaft or do a zigzag or any other shape or placement arrangement.

### OBJECT OF THE INVENTION

The invention promoted refers to a die-cut adhesive tape, formed from a conventional adhesive tape that has a series of die-cut lines perpendicular to its axis

### FIELD OF THE INVENTION

The field of the invention is that of adhesives, particularly adhesive tapes in all kinds of materials and having various resistances.

### BACKGROUND OF THE INVENTION

The market of adhesive tapes is very large and there are many kinds of tapes of various resistances and materials.

Within this market, the usual way to cut a piece of tape is to do it by external means.

These cutting means may be included in brackets with the tape roll or may be external elements like scissors, cutters, etc.

However, all the above cutting means present problems, in some cases because the brackets are bulky or heavy and In the case of external cutting elements merely for not having one at hand.

The proposed invention solves this problem perfectly; simply by exerting traction on the tape, it breaks by the weakest part which is the die line, without the aid of other elements

The inventor does not know any prior art that discloses the features of the present invention

### DESCRIPTION OF THE INVENTION

The invention features a die-cut tape, formed from a conventional adhesive tape that is rolled up around an axis which determines its storage as a roll and where a number of small die-cuts placed perpendicular to the main axis of the tape are performed in said adhesive tape at regular intervals.

This way when you want to use a particular piece of tape you only need to exert a pull on or near the die-cuts so that the tape breaks by that line, leaving a cut perpendicular and perfect, without assistance of any external element.

The distance between die-cut lines may vary depending on the needs of the industry.

### DESCRIPTION OF THE DRAWINGS

For a better understanding of the invention a sheet of drawings is included showing the following:

FIG. 1. Perspective view of a die-cut adhesive tape

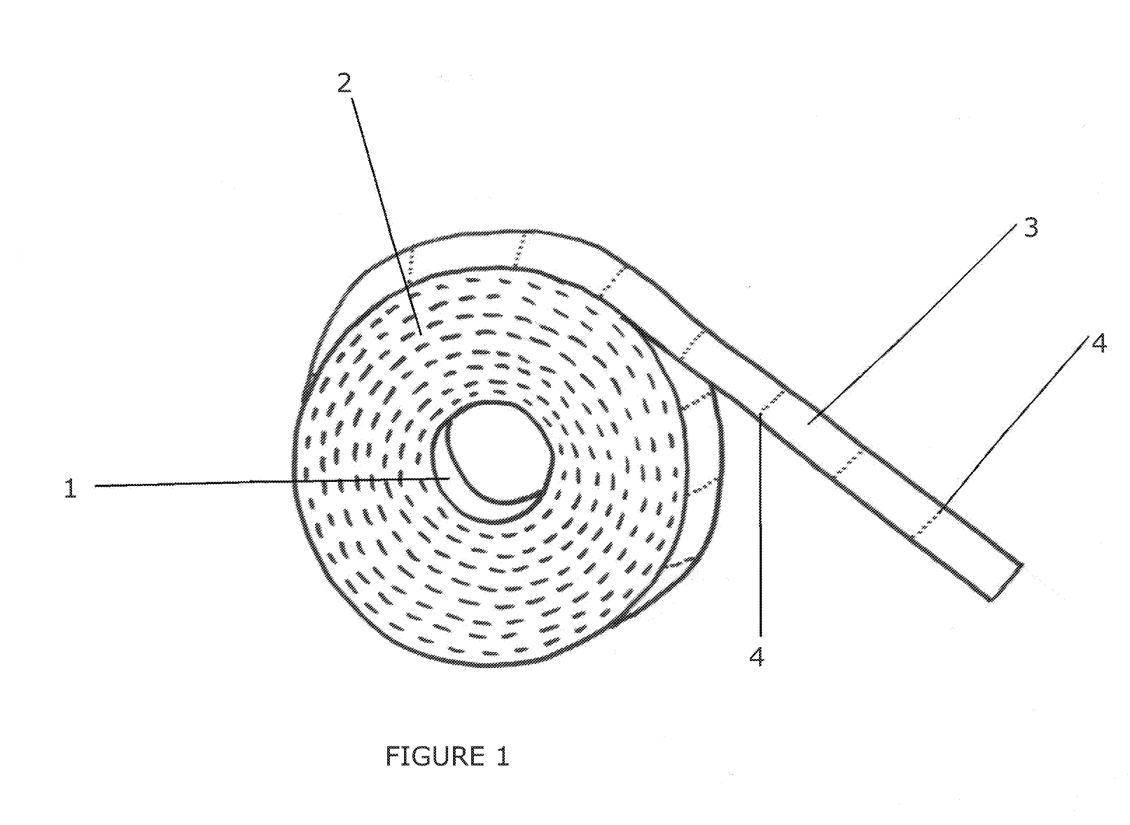

This FIG. shows the following elements:
1. Elastic band.
2. Roll of die-cut tape,
3. Die-cut tape.
4. Dies

### PREFERRED EMBODIMENT OF THE INVENTION

The invention consists of a die-cut tape, formed from a conventional adhesive tape (3) roiled on a shaft (1) determining its storage as a roll, where a series of small die-cuts (4) are made on said adhesive tape (3) perpendicular to the main axis of the tape (3) at regular intervals.

This way when you want to use a particular piece of tape (3) is only necessary to exert a pull on or near the die-cuts for the tape to break down that line, leaving a perpendicular and perfect cut. without assistance of any external element.

The distance between die-cut lines may vary depending on the needs of the industry and may not be perpendicular to the axis and even do a zigzag or any other shape.

Sufficiently described the nature of the invention, as well as how to be implemented, it must be stated that the provisions above mentioned and shown in the accompanying drawings, may be modified in detail as this would not alter its fundamental principles set out the above paragraphs and summarized in the following claims

1. Die-cut adhesive tape essentially characterized by being formed from a conventional adhesive tape (3) rolled on a shaft (1) determining its storage as a roll where a series of small dies (4) are made in said adhesive tape (3) placed perpendicular to the main axis of the tape (3) at regular intervals.

2. Die-cut adhesive tape according to claim 1 and characterized in that the distance between the lines of dies may be variable, the dies may be placed perpendicularly or obliquely from the main shaft or do a zigzag or any other shape or placement arrangement.
